(19) United States
(12) Patent Application Publication
(10) Pub. No.: US 2024/0422298 A1
(43) Pub. Date: Dec. 19, 2024

(54) VIDEO PROCESSING METHOD AND VIDEO PROCESSING SYSTEM

(71) Applicant: Panasonic Intellectual Property Management Co., Ltd., Osaka (JP)

(72) Inventors: Kengo Hayashi, Osaka (JP); Hiroaki Shimazaki, Osaka (JP); Norimitsu Sugiyama, Osaka (JP)

(21) Appl. No.: 18/680,270

(22) Filed: May 31, 2024

(30) Foreign Application Priority Data
Jun. 16, 2023 (JP) 2023-099103
May 9, 2024 (JP) 2024-076219

(51) Int. Cl. H04N 9/31

(52) U.S. Cl. CPC H04N 9/3182; H04N 9/3147

(57) ABSTRACT

A video processing method includes acquiring imaging information including an image obtained by imaging a plurality of videos respectively output by a plurality of video output devices as one video with an imaging device; calculating a first adjustment value for adjusting a color of a video output by a video output device based on the imaging information; acquiring a plurality of pieces of color information obtained by measuring respective colors of the plurality of videos; calculating a second adjustment value for adjusting a color of a video output by each of the video output device based on the plurality of pieces of color information and the first adjustment value; and outputting one, as the one video, of (i) a first video obtained by applying the first adjustment value to the video output device and (ii) a second video obtained by applying the second adjustment value to the video output device.

### BACKGROUND

### 1. Technical Field

The present disclosure relates to a video processing method and a video processing system.

### 2. Description of the Related Art

Patent Literature (PTL) 1 discloses a projector. The projector includes a measurement unit and a correction parameter generation unit. The measurement unit measures a plurality of colors constituting the RGB color system and the Z value of the XYZ color system. The correction parameter generation unit generates a correction parameter based on a first measured value obtained by converting the measured value of the color of the RGB color system measured by the measurement unit into the color of the XYZ color system and a second measured value of the XYZ color system measured by the measurement unit. The measurement unit includes an optical filter having a transmittance characteristic corresponding to a spectral characteristic of blue light in a wavelength region of color light of an RGB color system.
PTL 1: Unexamined Japanese Patent Publication No. 2020-34741

### SUMMARY

The present disclosure provides a video processing method and the like that facilitate adjustment of colors of a plurality of videos respectively output from a plurality of video output devices.

A video processing method according to one aspect of the present disclosure acquires imaging information including an image obtained by imaging a plurality of videos output from a plurality of video output devices, respectively as one video with an imaging device. In the video processing method, a first adjustment value for adjusting a color of a video output by each of one or more video output devices among the plurality of video output devices is calculated based on the imaging information. In the video processing method, a plurality of pieces of color information obtained by measuring respective colors of the plurality of videos are acquired. In the video processing method, a second adjustment value for adjusting a color of a video output by each of the one or more video output devices is calculated based on the plurality of pieces of color information and the first adjustment value. In the video processing method, the plurality of video output devices are caused to output one, as the one video, of (i) a first video obtained by applying the first adjustment value to the one or more video output devices and (ii) a second video obtained by applying the second adjustment value to the one or more video output devices as the one video.

The present disclosure has an advantage that colors of a plurality of videos output from a plurality of video output devices can be easily adjusted.

### BRIEF DESCRIPTION OF THE DRAWINGS

FIG. 1 is an explanatory diagram of an outline of a video processing method of a comparative example;

FIG. 2 is an explanatory diagram of spectral sensitivity characteristics;

FIG. 3 is an explanatory diagram of a problem of a video processing method of a comparative example;

FIG. 4 is a schematic diagram illustrating an overall configuration including a video processing system according to an exemplary embodiment;

FIG. 5 is an explanatory diagram illustrating measurement of spectral information in a projection device according to the exemplary embodiment;

FIG. 6 is a flowchart illustrating a measurement example of spectral information in the projection device according to the exemplary embodiment;

FIG. 7 is a flowchart illustrating an operation example of the video processing system according to the exemplary embodiment;

FIG. 8 is a view illustrating an example of a user interface of the video processing system according to the exemplary embodiment;

FIG. 9 is a view illustrating another example of the user interface of the video processing system according to the exemplary embodiment;

FIG. 10 is a schematic diagram illustrating an overall configuration including a video processing system according to a first modification of the exemplary embodiment; and

FIG. 11 is a schematic diagram illustrating an overall configuration including a video processing system according to a second modification of the exemplary embodiment.

### DETAILED DESCRIPTIONS

### 1. Knowledge on which the Present Disclosure is Based

First, a viewpoint of the inventors is described below.

Conventionally, there is known a video processing method (hereinafter, this is referred to as a “video processing method of a comparative example”) in which a plurality of videos projected on a display surface such as a screen by a plurality of projection devices (projectors) are set as one video, the one video is captured by an imaging device, and a color of the one video is adjusted using the captured image.

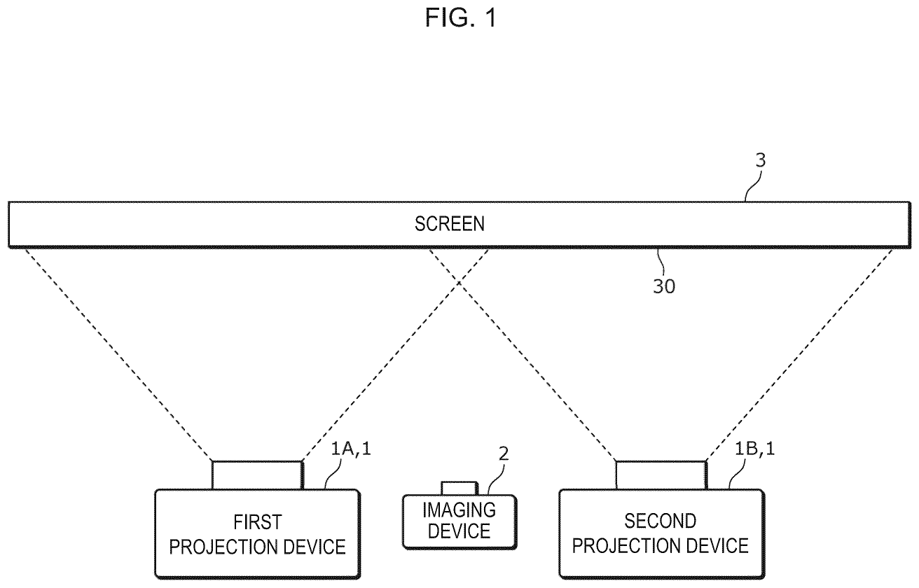

FIG. 1 is an explanatory diagram of an outline of a video processing method of a comparative example. In the video processing method of the comparative example, as illustrated in FIG. 1, one video is projected onto display surface 30 of screen 3 by projecting the video from each of the plurality of video output devices 1 (here, first projection device 1A and second projection device 1B). That is, first projection device 1A projects a left-half video of the one video onto a left-half region of display surface 30, and second projection device 1B projects a right-half video of the one video onto a right-half region of display surface 30. Imaging device 2 captures one video projected on display surface 30.

In the video processing method of the comparative example, the color of the video projected by first projection device 1A and the color of the video projected by second projection device 1B are adjusted based on the captured image obtained by imaging by imaging device 2. Specifically, for example, the same test pattern is projected from each of first projection device 1A and second projection device 1B onto display surface 30, and display surface 30 is imaged by imaging device 2. In the captured image, color correction is performed on the video output from at least one of first projection device 1A and second projection device 1B such that an RGB value of a region (here, the left half region of the captured image) corresponding to the test pattern projected from first projection device 1A is identical to an RGB value of a region (here, the right half region of the captured image) corresponding to the test pattern projected from second projection device 1B.

As described above, in the video processing method of the comparative example, by performing the color correction as described above, the color of the region corresponding to the video projected by first projection device 1A and the color of the region corresponding to the video projected by second projection device 1B are substantially the same in the captured image. By performing the color correction as described above, basically, when the person directly views display surface 30 (in other words, when one video is directly viewed), the color of the video projected by first projection device 1A and the color of the video projected by second projection device 1B become substantially the same.

In the video processing method of the comparative example, the color correction as described above can be performed in the case that the spectral characteristic of light output from first projection device 1A is identical to the spectral characteristic of light output from second projection device 1B. However, the video processing method of the comparative example has a problem that the above-described color correction is difficult when the spectral characteristic of light output from first projection device 1A and the spectral characteristic of light output from second projection device 1B are different from each other. For example, when first projection device 1A and second projection device 1B have different models, spectral characteristics of light output from first projection device 1A and second projection device 1B may be different from each other. When first projection device 1A and second projection device 1B are of the same model, the spectral characteristics of light output from first projection device 1A and second projection device 1B may be different from each other due to, for example, manufacturing variations.

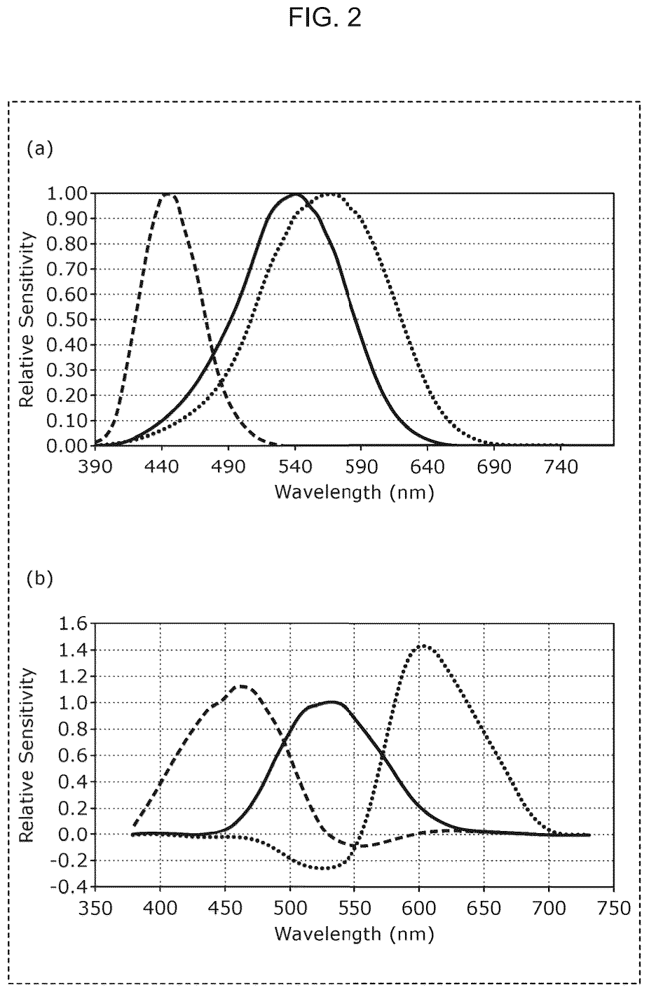

Hereinafter, the above problem will be described. FIG. 2 is an explanatory diagram of spectral sensitivity characteristics. Part (a) of FIG. 2 is a diagram illustrating an example of spectral sensitivity characteristics of human eyes, and part (b) of FIG. 2 is a diagram illustrating an example of spectral sensitivity characteristics of an image sensor included in imaging device 2. Here, the spectral sensitivity characteristics of the human eye are, for example, a standard spectral luminous efficiency function defined by the International Commission on Illumination (Commission internationale de l'eclairage: CIE).

In FIG. 2, the vertical axis represents relative sensitivity, and the horizontal axis represents wavelength. In FIG. 2, a broken line represents a spectral sensitivity characteristic corresponding to an S cone (blue), a solid line represents a spectral sensitivity characteristic corresponding to an M cone (green), and a dotted line represents a spectral sensitivity characteristic corresponding to an L cone (red). As illustrated in FIG. 2, the spectral sensitivity characteristic of the human eye and the spectral sensitivity characteristic of the image sensor of imaging device 2 are different from each other.

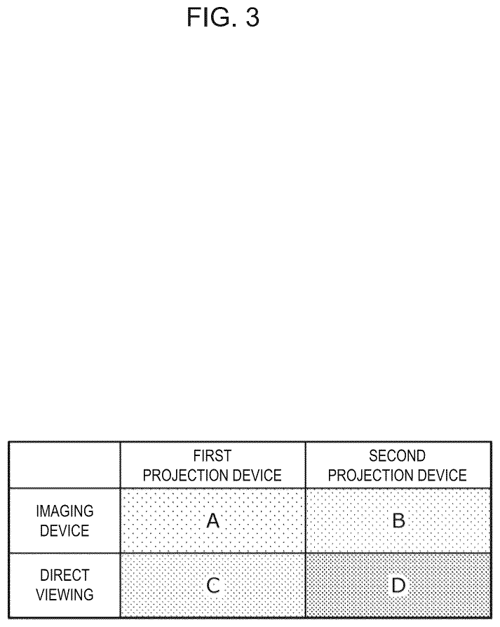

FIG. 3 is an explanatory diagram of a problem of the video processing method of the comparative example. In FIG. 3, the upper row indicates a color of a region corresponding to the video projected by first projection device 1A and a color of a region corresponding to the video projected by second projection device 1B in the captured image captured by imaging device 2. In FIG. 3, the lower row indicates a color of a video projected by first projection device 1A and a color of a video projected by second projection device 1B when the person directly views display surface 30. In FIG. 3, a difference in color is represented by a difference in the type of hatching.

Here, the color of the video is determined based on the spectrum of light output from video output device (projection device) 1 and the spectral sensitivity characteristic of the human eye receiving the light or the spectral sensitivity characteristic of an image sensor. Even when the spectra of light beams output from a plurality of projection devices 1 (here, first projection device 1A and second projection device 1B) are different from each other, in the video processing method of the comparative example, as illustrated in the upper row of FIG. 3, in the captured image, the color of the region corresponding to the video projected by first projection device 1A is substantially the same as the color of the region corresponding to the video projected by second projection device 1B. On the other hand, in the video processing method of the comparative example, as illustrated in the lower row of FIG. 3, the color of the video projected by first projection device 1A and the color of the video projected by second projection device 1B when the person directly views display surface 30 are different from each other.

Therefore, in the video processing method of the comparative example, while the color of one video appears uniform in the captured image, the color of one video differs between the left half region and the right half region when display surface 30 is viewed. In the video processing method of the comparative example, in order to reduce this phenomenon, imaging device 2 including an optical filter having the transmittance characteristic corresponding to the spectral characteristic of the blue light is used, but no countermeasure is taken for the green light and the red light. In addition, since the above-described optical filter is a special optical filter, there is also a problem that a general imaging device cannot be used. As described above, the video processing method of the comparative example has a problem that it may be difficult to adjust colors of a plurality of videos respectively output from a plurality of video output devices (projection devices) 1.

In view of the above, the inventors have created the present disclosure.

Hereinafter, exemplary embodiments will be described with reference to the drawings. Note that each of the exemplary embodiments described below illustrates a comprehensive or specific example. Numerical values, shapes, materials, components, arrangement positions and connection modes of the components, steps, order of the steps, and the like shown in the following exemplary embodiments are merely examples, and are not intended to limit the present disclosure. Further, among the components in the following exemplary embodiments, components not recited in the independent claims are described as arbitrary components.

Each drawing is a schematic diagram, and is not necessarily strictly illustrated. In the drawings, substantially the same components are denoted by the same reference numerals, and redundant description may be omitted or simplified.

### EXEMPLARY EMBODIMENT

### 2. Configuration

### 2-1. Overall Configuration

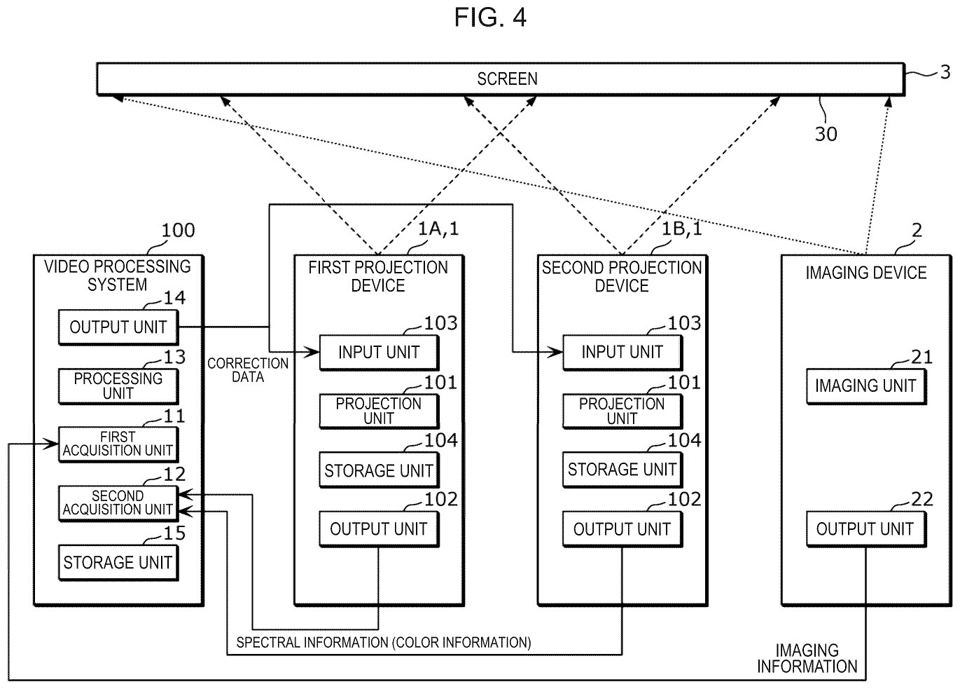

First, an overall configuration including video processing system 100 according to the exemplary embodiment will be described. FIG. 4 is a schematic diagram illustrating an overall configuration including video processing system 100 according to the exemplary embodiment. Video processing system 100 is a system that adjusts colors of a plurality of videos respectively output from the plurality of video output devices 1. In the exemplary embodiment, video processing system 100 is used together with a plurality of video output devices 1, imaging device 2, and screen 3. In the exemplary embodiment, each of the plurality of video output devices 1 is a projection device. Hereinafter, unless otherwise specified, “video output device 1” is referred to as “projection device 1”. In the exemplary embodiment, the plurality of projection devices 1 are first projection device 1A and second projection device 1B.

Projection device 1 is a device having a projector function, and projects a video onto display surface 30 of screen 3 based on video data included in a video signal transmitted from a reproduction device (not shown). Note that projection device 1 is not limited to a mode of projecting a video on display surface 30 of screen 3, and may be a mode of projecting a video by using one surface of a structure other than the screen, such as a wall surface, as display surface 30.

The reproduction device is a device having a function of reproducing a video recorded on an optical medium such as a digital versatile disc (DVD) (registered trademark) or a Blu-ray (registered trademark) disc (BD), for example. Note that the reproduction device may be, for example, a device having a function of reproducing a video recorded in a storage device such as a hard disc drive (HDD).

In the exemplary embodiment, one video including a plurality of videos respectively output from the plurality of projection devices 1 is projected on display surface 30. Specifically, first projection device 1A projects a left-half video of the one video onto a left-half region of display surface 30. Second projection device 1B projects a right-half video of the one video onto a right-half region of display surface 30. Consequently, one video obtained by combining the video projected from first projection device 1A and the video projected from second projection device 1B is projected on display surface 30.

Projection device 1 includes projection unit 101, output unit 102, input unit 103, and storage unit 104.

Projection unit 101 projects a video onto display surface 30 in accordance with a video signal transmitted from the reproduction device. In the exemplary embodiment, projection unit 101 performs color correction on the video to be output according to the correction data input to input unit 103, and projects the color-corrected video onto display surface 30. Although described in detail later, the correction data input to input unit 103 is one of a first adjustment value and a second adjustment value. Therefore, projection unit 101 projects, onto display surface 30, one of the video color-corrected using the first adjustment value and the video color-corrected using the second adjustment value.

Output unit 102 is a communication interface for communicating with video processing system 100. Output unit 102 outputs spectral information as color information. The spectral information is information indicating a spectrum of light output from projection device (video output device) 1. In the exemplary embodiment, the spectral information includes a measurement value of a spectral spectrum of light output from projection device 1. The spectral information is stored in storage unit 104. Therefore, output unit 102 reads the spectral information from storage unit 104, and outputs the read spectral information to video processing system 100 as the color information. Note that communication between output unit 102 and video processing system 100 may be wired communication or wireless communication.

Input unit 103 is a communication interface for communicating with video processing system 100. Correction data output from video processing system 100 is input to input unit 103. Correction data input to input unit 103 is used for color correction of video output from projection unit 101. The content of the correction data input to input unit 103 may be different for each projection device 1. In addition, there is a case that the correction data is not input to input unit 103. In this case, projection device 1 including input unit 103 projects a video onto display surface 30 without performing color correction. Note that communication between input unit 103 and video processing system 100 may be wired communication or wireless communication. Furthermore, output unit 102 and input unit 103 may be realized by one communication interface.

Storage unit 104 is, for example, a semiconductor memory or the like, and stores various parameters to be referred to when projection device 1 operates. In the exemplary embodiment, in addition to the various parameters, the storage unit 104 further stores spectral information as color information.

Imaging device 2 is a device having a camera function, and captures a video projected onto display surface 30. In the exemplary embodiment, imaging device 2 is a device different from projection device 1, but may be incorporated in projection device 1. For example, imaging device 2 may be incorporated in either one of first projection device 1A and second projection device 1B.

Imaging device 2 includes imaging unit 21 and output unit 22.

Imaging unit 21 includes an image sensor, and captures a video projected onto display surface 30. In the exemplary embodiment, when receiving an imaging start command from video processing system 100, imaging unit 21 captures the video projected onto display surface 30. Here, the video captured by imaging unit 21 is one video (that is, a plurality of videos projected onto display surface 30 by each of the plurality of projection devices 1) projected onto entire display surface 30.

Output unit 22 is a communication interface for communicating with video processing system 100. Output unit 22 outputs imaging information including an image captured by imaging unit 21 to video processing system 100. Note that communication between output unit 22 and video processing system 100 may be wired communication or wireless communication.

### 2-2. Video Processing System

Next, a configuration of video processing system 100 will be described in detail. Video processing system 100 is, for example, an information terminal such as a desktop type or laptop type personal computer, and controls each of projection devices 1 and imaging device 2 by communicating with each of projection devices 1 and imaging device 2 via a network such as a local area network (LAN). Communication between each of projection devices 1 and imaging device 2 and video processing system 100 is performed according to a known network protocol such as a hypertext transfer protocol (HTTP), a file transfer protocol (FTP), or a transmission control protocol (TCP).

In the exemplary embodiment, video processing system 100 is implemented by installing dedicated software in video processing system 100 in a general-purpose information terminal. Note that video processing system 100 is not limited to a general-purpose information terminal, and may be an information terminal dedicated to video processing system 100. Furthermore, the information terminal is not limited to a personal computer, and may be realized by, for example, a smartphone, a tablet terminal, or the like.

Video processing system 100 includes first acquisition unit 11, second acquisition unit 12, processing unit 13, output unit 14, and storage unit 15. Each of first acquisition unit 11, second acquisition unit 12, processing unit 13, and output unit 14 may be implemented by a dedicated circuit, or may be implemented by a processor executing a corresponding computer program stored in a memory.

First acquisition unit 11 is a communication interface for communicating with imaging device 2. First acquisition unit 11 acquires imaging information output from imaging device 2. Here, the imaging information is information including an image obtained by imaging a plurality of videos output from the plurality of projection devices (video output devices) 1 as one video by imaging device 2. In other words, the imaging information is information including an image obtained by imaging one video projected onto display surface 30 with imaging device 2.

Second acquisition unit 12 is a communication interface for communicating with each of the plurality of projection devices (video output devices) 1. Second acquisition unit 12 acquires a plurality of pieces of color information output from each of the plurality of projection devices 1. The plurality of pieces of color information are information obtained by measuring respective colors of the plurality of videos. In the exemplary embodiment, each of the plurality of pieces of color information is spectral information indicating a spectrum of light output from corresponding projection device 1. Specifically, the plurality of pieces of color information include color information of first projection device 1A including a measurement value of the spectral spectrum obtained by measuring light output from first projection device 1A with spectrometry device 4 (described later), and color information of second projection device 1B including a measurement value of the spectral spectrum obtained by measuring light output from second projection device 1B with spectrometry device 4. The color information is not limited to the measurement value of the spectral spectrum, and may be information indicating the color of the video output from projection device 1, such as a color value calculated by an appropriate color system based on the measurement value of the spectral spectrum. That is, each of the plurality of pieces of color information may be a color value calculated using a color system based on a spectrum of light output from corresponding projection device (video output device) 1. Here, the color system may be an XYZ color system (CIE 1931 standard color system), an L*u*v* color system (CIE 1976 Luv color space), an L*a*b* color system (CIE 1976 Lab color space), a Munsell color system, or the like, but is not limited thereto.

Processing unit 13 has a function of executing processing of adjusting colors of a plurality of videos respectively output from the plurality of projection devices 1. In the exemplary embodiment, processing unit 13 executes the following three processing.

First, processing unit 13 executes processing of calculating the first adjustment value based on the imaging information acquired by first acquisition unit 11. The first adjustment value is a value for adjusting the color of the video output from each of one or more projection devices 1 among the plurality of projection devices (video output devices) 1. The first adjustment value may be a value for adjusting only the color of the video output from first projection device 1A or a value for adjusting only the color of the video output from second projection device 1B. The first adjustment value may be a value for adjusting both the color of the video output from first projection device 1A and the color of the video output from second projection device 1B.

In the exemplary embodiment, processing unit 13 calculates a representative value of the RGB values of a region corresponding to the video projected by first projection device 1A and a representative value of the RGB values of a region corresponding to the video projected by second projection device 1B in the image captured by imaging device 2. Here, the image captured by imaging device 2 is, for example, a test pattern including a uniform pattern over entire display surface 30. The representative value is, for example, an average value, a median value, a mode value, or the like. Then, processing unit 13 calculates a difference between the calculated representative values of RGB of projection devices 1A, 1B as a first adjustment value. Note that, here, the first adjustment value is calculated as a value for adjusting the color of the video output by any one of projection devices 1.

Secondly, processing unit 13 executes processing of calculating the second adjustment value based on the plurality of pieces of color information acquired by second acquisition unit 12 and the first adjustment value. The second adjustment value is a value for adjusting the color of the video output from each of one or more projection devices (video output devices) 1, and is a value different from the first adjustment value. Similarly to the first adjustment value, the second adjustment value may be a value for adjusting only the color of the video output from first projection device 1A, or may be a value for adjusting only the color of the video output from second projection device 1B. The second adjustment value may be a value for adjusting both the color of the video output from first projection device 1A and the color of the video output from second projection device 1B.

In the exemplary embodiment, processing unit 13 calculates an offset value based on the difference between the plurality of pieces of color information, and calculates the second adjustment value based on the calculated offset value and the first adjustment value. Specifically, processing unit 13 calculates, for each projection device 1, an offset value that is a difference between a value obtained by integrating the color information (here, a measurement value of a spectral spectrum of light output from projection device 1) and the spectral sensitivity characteristic of the human eye and a value obtained by integrating the color information and the spectral sensitivity characteristic of the image sensor of imaging device 2. Then, processing unit 13 calculates the second adjustment value by adding the calculated offset value for each projection device 1 to the first adjustment value.

Third, processing unit 13 executes processing for causing the plurality of projection devices (video output devices) 1 to output one of the first video and the second video as one video.

The first video is a video obtained by applying the first adjustment value to one or more projection devices 1. In the case that the first video is output to the plurality of projection devices 1, processing unit 13 outputs the first adjustment value as the correction data from output unit 14 to each projection device 1. Each of one or more projection devices 1 corrects the color of the video to be output by using the first adjustment value input to input unit 103. Consequently, the plurality of videos (one video) projected onto display surface 30 becomes a video in which the color is corrected by the first adjustment value.

The second video is a video obtained by applying the second adjustment value to one or more projection devices 1. In the case that the second video is output to the plurality of projection devices 1, processing unit 13 outputs the second adjustment value as the correction data from output unit 14 to each projection device 1. Each of one or more projection devices 1 corrects the color of the video to be output by using the second adjustment value input to input unit 103. Consequently, the plurality of videos (one video) projected onto display surface 30 becomes a video in which the color is corrected by the second adjustment value.

Here, the first video is a video in which, when each of projection devices 1 projects the same video onto display surface 30, colors are substantially the same over the entire one video in the image captured by imaging device 2. That is, it can be said that the first adjustment value is a value for adjusting the colors of the plurality of videos to be close to each other in the image captured by imaging device 2 when the plurality of videos are all the same videos.

Further, the second video is a video in which, when each of projection devices 1 projects the same video onto display surface 30, colors are substantially the same over the entire one video when a person directly views display surface 30. That is, it can be said that the second adjustment value is a value for adjusting the colors of the plurality of videos to be close to each other when one video is directly viewed in a case where the plurality of videos are all the same videos.

Output unit 14 is a communication interface for communicating with each of the plurality of projection devices (video output devices) 1. Output unit 14 outputs one of the first adjustment value and the second adjustment value calculated by processing unit 13 to one or more projection devices 1 as correction data. In the exemplary embodiment, output unit 14 outputs the correction data to each of first projection device 1A and second projection device 1B.

Storage unit 15 is, for example, a semiconductor memory or the like, and stores various parameters to be referred to when video processing system 100 operates. In the exemplary embodiment, storage unit 15 stores spectral information for each projection device 1 in addition to the various parameters. In addition, storage unit 15 stores the first adjustment value and the second adjustment value calculated by processing unit 13.

### 3. Operation

Hereinafter, an operation of video processing system 100 according to the exemplary embodiment, that is, a video processing method according to the exemplary embodiment will be described.

### 3-1. Measurement of Color Information

First, measurement of color information (here, spectral information) in projection device (video output device) 1 will be described. In the exemplary embodiment, the measurement of the spectral information is performed when projection device 1 is shipped from the factory. However, the timing of the measurement is not particularly limited, and the measurement may be performed at a time point before the time point at which the spectral information is acquired in video processing system 100. For example, the spectral information may be periodically measured after the shipment of projection device 1, and the content stored in storage unit 104 may be updated.

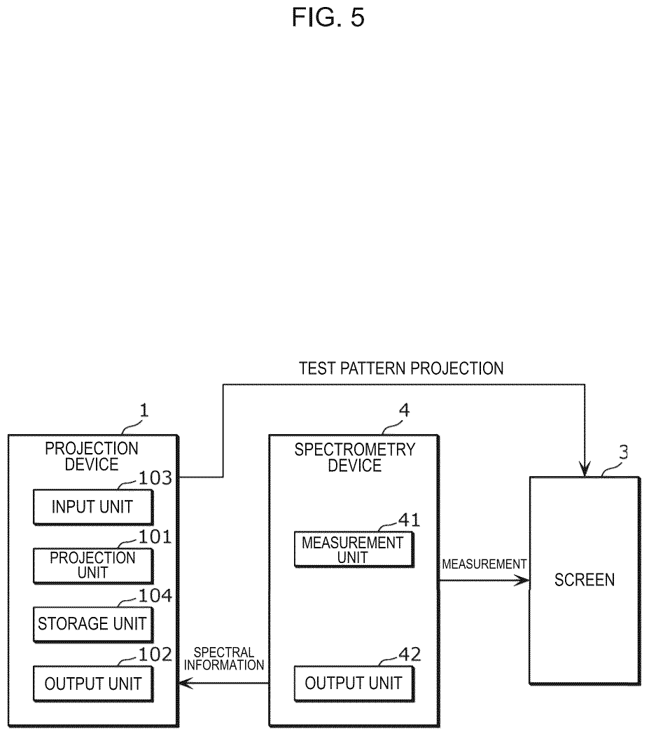

FIG. 5 is an explanatory diagram illustrating measurement of spectral information in projection device 1 according to the exemplary embodiment. As illustrated in FIG. 5, spectrometry device 4 is used to measure the spectral information in projection device 1. Spectrometry device 4 includes measurement unit 41 and output unit 42.

Measurement unit 41 measures an electromagnetic wave spectrum of light projected from projection device 1 and reflected by display surface 30 of screen 3. In the exemplary embodiment, measurement unit 41 measures the electromagnetic wave spectrum of the light reflected by display surface 30, thereby measuring a measurement value of the spectral spectrum of the light output from projection device 1 as the spectral information.

Output unit 42 is a communication interface for communicating with projection device 1. Output unit 42 outputs the spectral information measured by measurement unit 41 to projection device 1. Note that communication between output unit 42 and projection device 1 may be wired communication or wireless communication.

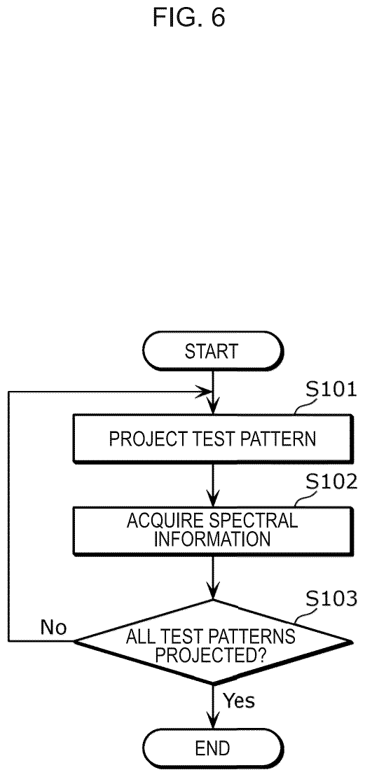

FIG. 6 is a flowchart illustrating an example of measurement of spectral information in projection device 1 according to the exemplary embodiment. Measurement of spectral information described below is executed for each projection device 1.

First, projection unit 101 of projection device 1 projects the test pattern onto display surface 30 of screen 3 (S101). Here, projection unit 101 sequentially projects a total of three types of test patterns including a test pattern for a red (R) channel, a test pattern for a green (G) channel, and a test pattern for a blue (B) channel onto display surface 30. For example, projection unit 101 first projects the test pattern for the R channel onto display surface 30.

Next, measurement unit 41 of spectrometry device 4 measures the electromagnetic wave spectrum of the light reflected by display surface 30 to measure a measurement value of the spectral spectrum of the light as spectral information. Output unit 42 of spectrometry device 4 outputs the spectral information measured by measurement unit 41 to projection device 1. Consequently, projection device 1 acquires the spectral information (S102), and stores the acquired spectral information in storage unit 104.

Here, when not all the test patterns are projected onto display surface 30 (S103: No), steps S101 and S102 are repeated for the next test pattern. For example, after the spectral information is measured for the test pattern for the R channel, measurement of the spectral information for the test pattern for the G channel and measurement of the spectral information for the test pattern for the B channel are sequentially executed. When all the test patterns are projected onto display surface 30 (S103: Yes), the measurement of the spectral information is ended.

The test pattern projected onto display surface 30 may be, for example, only a test pattern for a W (white) channel.

### 3-2. Operation of Video Processing System

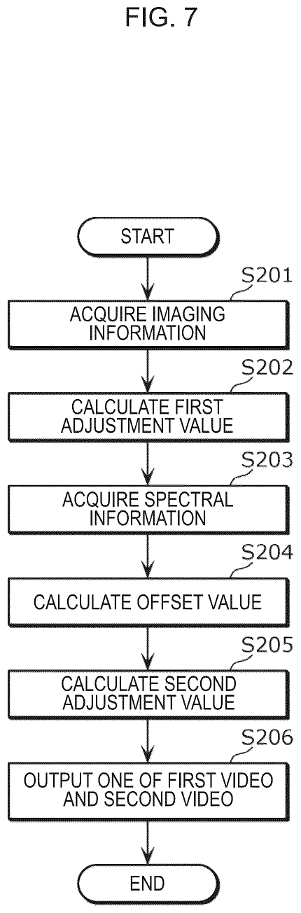

Next, an operation (that is, the video processing method) of video processing system 100 according to the exemplary embodiment will be described. FIG. 7 is a flowchart illustrating an operation example of video processing system 100 according to the exemplary embodiment.

First, projection unit 101 of each projection device 1 projects a test pattern onto display surface 30 of screen 3. Next, imaging unit 21 of imaging device 2 captures a video projected onto display surface 30. Then, output unit 22 of imaging device 2 outputs imaging information including the image captured by imaging unit 21 to video processing system 100. Consequently, first acquisition unit 11 of video processing system 100 acquires the imaging information (S201).

Next, processing unit 13 of video processing system 100 calculates the first adjustment value based on the imaging information acquired by first acquisition unit 11 (S202). Output unit 102 of each projection device 1 reads the spectral information from storage unit 104, and outputs the read spectral information to video processing system 100. Consequently, second acquisition unit 12 of video processing system 100 acquires the spectral information from each projection device 1 (S203). For example, processing unit 13 of video processing system 100 requests each projection device 1 to output the spectral information by output unit 102 of each projection device 1.

Next, processing unit 13 of video processing system 100 calculates the offset value based on the difference between the plurality of pieces of spectral information acquired by second acquisition unit 12 from each of the plurality of projection devices 1 (S204). Then, processing unit 13 calculates the second adjustment value based on the calculated offset value and the first adjustment value (S205).

Then, processing unit 13 of video processing system 100 outputs one of the first video and the second video as one video to the plurality of projection devices 1 (S206). In the exemplary embodiment, processing unit 13 causes the plurality of projection devices 1 to output one of the first video and the second video as one video according to the input from the user. Hereinafter, the input by the user will be described.

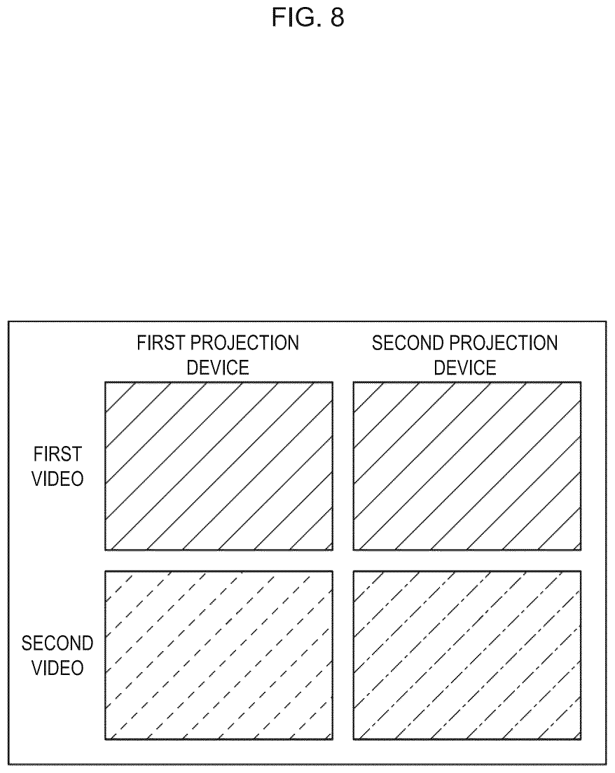

FIG. 8 is a diagram illustrating an example of a user interface of video processing system 100 according to the exemplary embodiment. This user interface is displayed on, for example, a display included in video processing system 100 or a display connected to video processing system 100. In the example illustrated in FIG. 8, an image indicating the first video and an image indicating the second video are displayed on the display. The image indicating the first video further includes an image corresponding to the video projected by first projection device 1A and an image corresponding to the video projected by second projection device 1B. The image indicating the second video further includes an image corresponding to the video projected by first projection device 1A and an image corresponding to the video projected by second projection device 1B.

In FIG. 8, a difference in color is represented by a difference in the type of hatching. In the image indicating the second video, the color of the image corresponding to the video projected by first projection device 1A is different from the color of the image corresponding to the video projected by second projection device 1B, but this is the color of the image captured by imaging device 2, and when the user directly views display surface 30, the colors of these images are substantially the same on display surface 30.

The user checks the image indicating the first video and the image indicating the second video displayed on the display to perform input for selecting which of the first video and the second video is output to the plurality of projection devices 1. For example, in a case where the user desires a video adjusted to have a uniform color in the image captured by imaging device 2, the user performs an input to select the first video. Furthermore, for example, in a case where the user desires a video adjusted to have a uniform color when the user directly views display surface 30, the user performs an input to select the second video.

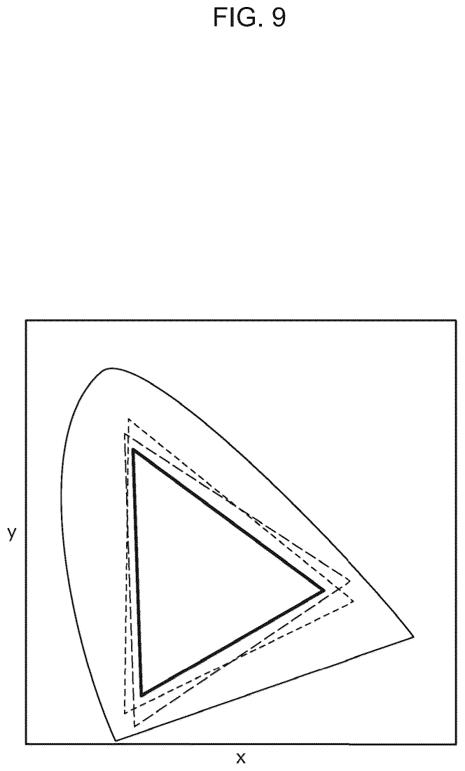

Meanwhile, in video processing system 100 according to the exemplary embodiment, the user can not only select one of the first video and the second video, but also perform more detailed color correction. FIG. 9 is a diagram illustrating another example of the user interface of video processing system 100 according to the exemplary embodiment. This user interface is displayed on a display included in video processing system 100 or a display connected to video processing system 100, for example, when the user performs detailed color correction.

In the example shown in FIG. 9, a CIE xy chromaticity diagram is displayed on the display. In the xy chromaticity diagram, a solid triangle represents a target color gamut of color correction, a dotted line represents a color gamut of light projected by first projection device 1A, and a broken line represents a color gamut of light projected by second projection device 1B. The user can also cause the plurality of projection devices 1 to output a video different from the first video and the second video by adjusting the position of the solid triangle.

### 4. Advantages and the Like

Advantages of video processing system 100 (video processing method) of the exemplary embodiment will be described below. As described above, in video processing system 100 according to the exemplary embodiment, it is possible to cause the plurality of projection devices (video output devices) 1 to output, as one video, one of the first video color-corrected using the first adjustment value and the second video color-corrected using the second adjustment value. Therefore, in video processing system 100 according to the exemplary embodiment, when the spectral characteristics of light beams output from the plurality of projection devices 1 are different from each other, it is possible to cause the video corrected so as to have a uniform color in the image captured by imaging device 2 to be projected onto display surface 30, or to cause the video corrected so as to have a uniform color when the person directly views display surface 30 to be projected onto display surface 30. Hence, video processing system 100 according to the exemplary embodiment has an advantage that it is easy to adjust colors of a plurality of videos respectively output from a plurality of projection devices (video output devices) 1.

In video processing system 100 according to the exemplary embodiment, when second acquisition unit 12 acquires the plurality of pieces of color information (here, spectral information), the plurality of pieces of spectral information are acquired from the plurality of storage units 104 of each of the plurality of projection devices 1. For this reason, in video processing system 100 according to the exemplary embodiment, when the spectral information is stored in advance in storage unit 104 of each projection device 1, there is an advantage that the spectral information does not need to be measured when the colors of the plurality of videos are adjusted. Then, when the spectral information is measured, a relatively expensive and difficult to procure device such as the spectrometry device 4 is required, but since the user does not need to prepare such a device, there is an advantage that the colors of a plurality of videos are easily adjusted.

### 5. Other Exemplary Embodiments

Although the exemplary embodiment has been described above, the present disclosure is not limited to the exemplary embodiment.

### 5-1. First Modification

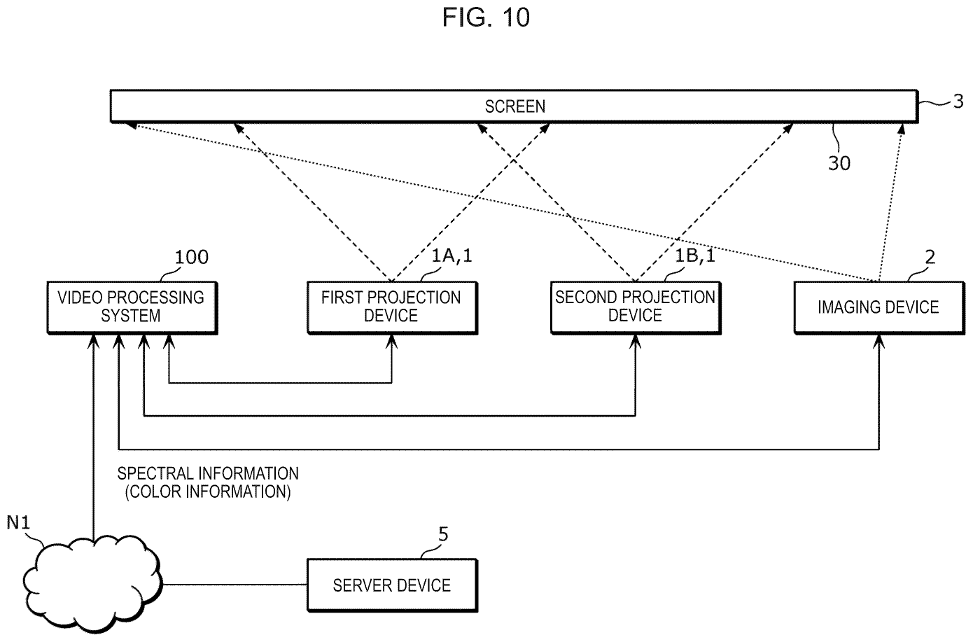

FIG. 10 is a schematic diagram illustrating an entire configuration including video processing system 100 according to a first modification of the exemplary embodiment. As illustrated in FIG. 10, the first modification is different from video processing system 100 according to the exemplary embodiment in that video processing system 100 does not acquire a plurality of pieces of color information (here, spectral information) from each projection device 1, but acquires a plurality of pieces of spectral information from server device 5 via network N1 such as the Internet.

In the first modification, in the above-described [3-1. Measurement of color information], not projection device 1 but server device 5 is caused to store the measured spectral information. For each projection device 1, server device 5 stores the identifier of projection device 1 and the measured spectral information in association with each other. Therefore, in the first modification, second acquisition unit 12 of video processing system 100 can acquire a plurality of pieces of spectral information from server device 5 by communicating with server device 5 via network N1.

### 5-2. Second Modification

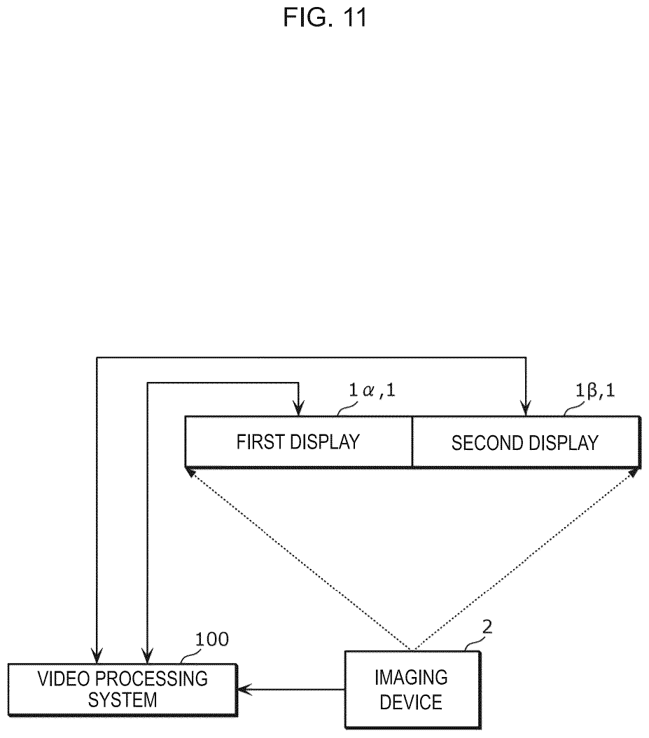

FIG. 11 is a schematic diagram illustrating an overall configuration including video processing system 100 according to a second modification of the exemplary embodiment. As illustrated in FIG. 11, video output device 1 according to the second modification is different from video processing system 100 according to the exemplary embodiment in that video output device 1 is not a projection device but a display.

In the second modification, a plurality of displays 1 (here, first display 1α and second display 1β) respectively output videos to output one video. That is, first display 1α outputs a video of the left half of the one video, and second display 1β outputs a video of the right half of the one video. Then, imaging device 2 captures one video output from these displays 1.

Also in the second modification, similarly to the exemplary embodiment, video processing system 100 can cause the plurality of displays 1 to output one of the first video color-corrected using the first adjustment value and the second video color-corrected using the second adjustment value as one video.

### 5-3. Other Modifications

For example, in the above exemplary embodiment, processing unit 13 of video processing system 100 may cause the plurality of video output devices 1 to output the first video when the calculated offset value is smaller than a threshold. This is because when the offset value is sufficiently small, the first adjustment value and the second adjustment value are substantially the same, and the first video and the second video are also substantially the same.

Furthermore, in the above-described exemplary embodiment, processing unit 13 of video processing system 100 causes the plurality of video output devices 1 to output one of the first video and the second video according to the input of the user, but the present disclosure is not limited thereto. For example, processing unit 13 of video processing system 100 may cause the plurality of video output devices 1 to output one of the first video and the second video according to a preset condition regardless of the input of the user.

In the exemplary embodiment, processing unit 13 of video processing system 100 may cause the plurality of video output devices 1 to output the second video as one video, and may cause the plurality of video output devices 1 to output the first video as a distribution video distributed via network N1. In this aspect, the second video is output when the user directly views one video, and the first video is output when the user views the distribution video via the display or the like. Therefore, there is an advantage that the user can view the video appropriately corrected in both cases.

Furthermore, in the above-described exemplary embodiment, the number of the plurality of video output devices 1 is two, but the present disclosure is not limited thereto, and the number of the plurality of video output devices 1 may be three or more.

In addition, in the above-described exemplary embodiment, video processing system 100 is realized by a single device, but the present disclosure is not limited thereto. For example, video processing system 100 may be realized by a plurality of devices. That is, the plurality of components included in video processing system 100 may be distributed to two or more devices.

In addition, in the above exemplary embodiment, processing executed by a specific processing unit may be executed by another processing unit. Furthermore, the order of a plurality of processing may be changed, or a plurality of processing may be executed in parallel.

In the above exemplary embodiments, each component may be implemented by executing a software program suitable for each component. Each component may be implemented by causing a program-execution unit, such as a CPU or a processor, to read and execute a software program stored in a recording medium, such as a hard disk or a semiconductor memory.

In addition, each component may be implemented by hardware. Each component may be a circuit (or an integrated circuit). These circuits may constitute one circuit as a whole or may be separate circuits. Each of these circuits may be a general-purpose circuit or a dedicated circuit.

In addition, the general or specific aspect of the present disclosure may be realized by a system, an apparatus, a method, an integrated circuit, a computer program, or a computer-readable recording medium such as a CD-ROM. In addition, the present disclosure may be implemented by an arbitrary combination of a system, an apparatus, a method, an integrated circuit, a computer program, and a recording medium.

Further, the present disclosure may be implemented as a video processing method executed by a computer such as the video processing system of the above exemplary embodiment. The present disclosure may be implemented as a program (computer program product) for causing a computer to execute such a video processing method, or may be realized as a computer-readable non-transitory recording medium in which such a program is recorded.

In addition, the present disclosure also includes a mode obtained by applying various modifications conceived by those skilled in the art to each exemplary embodiment, or a mode realized by arbitrarily combining components and functions in each exemplary embodiment without departing from the gist of the present disclosure.

(Conclusion) As described above, in a video processing method according to a first aspect, imaging information including an image obtained by imaging a plurality of videos respectively output by a plurality of video output devices 1 as one video with imaging device 2 is acquired. Further, in this video processing method, a first adjustment value for adjusting a color of a video output by each of one or more video output devices 1 among the plurality of video output devices 1 is calculated based on the imaging information. In addition, in this video processing method, a plurality of pieces of color information obtained by measuring respective colors of the plurality of videos is acquired. In the video processing method, a second adjustment value for adjusting a color of a video output by each of the one or more video output devices 1 is calculated based on the plurality of pieces of color information and the first adjustment value. Further, in this video processing method, one of (i) a first video obtained by applying the first adjustment value to one or more video output devices 1 and (ii) a second video obtained by applying the second adjustment value to one or more video output devices 1 is output as the one video from the plurality of video output devices 1.

In such a video processing method, any one of the first video color-corrected using the first adjustment value and the second video color-corrected using the second adjustment value is output as one video to the plurality of video output devices 1, so that there is an advantage that the colors of the plurality of videos output from the plurality of video output devices 1 can be easily adjusted.

Furthermore, for example, in a video processing method according to a second aspect, in the first aspect, one of the first video and the second video is output as the one video from the plurality of video output devices 1 according to an input by the user.

In such a video processing method, since the user can select which of the first video and the second video is to be output, there is an advantage that it is easy to output a video according to user's preference.

Furthermore, for example, in a video processing method according to a third aspect, in the first or second aspect, each of the plurality of pieces of color information is spectral information indicating a spectrum of light output from corresponding video output device 1.

In such a video processing method, by adjusting colors of a plurality of videos by using spectral information, there is an advantage that it is easy to correct a color difference that is difficult to distinguish from a captured image obtained by imaging by imaging device 2.

Furthermore, for example, in a video processing method according to a fourth aspect, in the first or second aspect, each of the plurality of pieces of color information is a color value calculated using a color system based on a spectrum of light output from corresponding video output device 1.

In such a video processing method, by adjusting colors of a plurality of videos by using color values, there is an advantage that it is easy to correct a color difference that is difficult to distinguish from a captured image obtained by imaging by imaging device 2.

Furthermore, for example, in a video processing method according to a fifth aspect, in the calculating of the second adjustment value in any one of the first to fourth aspects, the offset value based on the difference between the plurality of pieces of color information is calculated, and the second adjustment value is calculated based on the calculated offset value and the first adjustment value.

In such a video processing method, since the colors of the plurality of videos are adjusted in consideration of the difference between the plurality of pieces of color information, there is an advantage that the colors of the plurality of videos output from the plurality of video output devices 1 are easily adjusted with high accuracy.

Furthermore, for example, in a video processing method according to a sixth aspect, in any one of the first to fifth aspects, in the acquiring of the plurality of pieces of color information, the plurality of pieces of color information are acquired from a plurality of storage units 104 respectively included in the plurality of video output devices 1.

In such a video processing method, when the color information is stored in advance in the storage unit 104 of each video output device 1, there is an advantage that it is not necessary to measure the color information when adjusting the colors of the plurality of videos.

Furthermore, for example, in a video processing method according to a seventh aspect, in any one of the first to fifth aspects, in the acquiring of the plurality of pieces of color information, the plurality of pieces of color information are acquired from server device 5 via network N1.

In such a video processing method, when a plurality of pieces of color information are stored in advance in server device 5, there is an advantage that it is not necessary to measure the color information when adjusting the colors of the plurality of videos.

Furthermore, for example, in any one of the first to seventh aspects, a video processing method according to an eighth aspect causes the plurality of video output devices 1 to output the second video as the one video, and the first video as a distribution video distributed via network N1.

In such a video processing method, the second video is output when the user directly views one video, and the first video is output when the user views the distribution video via the display or the like. Therefore, there is an advantage that the user can view the video appropriately corrected in both cases.

Furthermore, for example, in a video processing method according to a ninth aspect, in any one of the first to eighth aspects, the first adjustment value is a value for adjusting colors of the plurality of videos to be close to each other in the image captured by imaging device 2 in a case where the plurality of videos are a same video. The second adjustment value is a value for adjusting colors of the plurality of videos to be close to each other when the one video is directly viewed in a case where the plurality of videos are the same video.

In such a video processing method, there is an advantage that when the first video is output, the color of one video is easily seen uniformly when the image captured by the imaging device (in addition to imaging device 2, a general camera is included) is viewed, and when the second video is output, the color of one video is easily seen uniformly when the one video is directly viewed.

Furthermore, for example, video processing system 100 according to a tenth aspect includes first acquisition unit 11, second acquisition unit 12, and processing unit 13. First acquisition unit 11 acquires imaging information including an image obtained by imaging a plurality of videos respectively output from a plurality of video output devices 1 as one video with imaging device 2. Second acquisition unit 12 acquires a plurality of pieces of color information obtained by measuring respective colors of the plurality of videos. Processing unit 13 calculates, based on the imaging information acquired by first acquisition unit 11, a first adjustment value for adjusting a color of a video output by each of one or more video output devices 1 among the plurality of video output devices 1. Further, processing unit 13 calculates a second adjustment value for adjusting a color of a video output by each of one or more video output devices 1 based on the plurality of pieces of color information acquired by second acquisition unit 12 and the first adjustment value. Furthermore, processing unit 13 causes the plurality of video output devices 1 to output one, as the one video, of (i) a first video obtained by applying the first adjustment value to one or more video output devices 1 and (ii) a second video obtained by applying the second adjustment value to one or more video output devices 1.

Since such video processing system 100 causes the plurality of video output devices 1 to output one of the first video color-corrected using the first adjustment value and the second video color-corrected using the second adjustment value as one video, there is an advantage that it is easy to adjust the colors of the plurality of videos respectively output from the plurality of video output devices 1.

What is claimed is:

1. A video processing method comprising:
acquiring imaging information including an image obtained by imaging a plurality of videos respectively output by a plurality of video output devices as one video with an imaging device;
calculating a first adjustment value for adjusting a color of a video output by each of one or more video output devices among the plurality of video output devices based on the imaging information;
acquiring a plurality of pieces of color information obtained by measuring respective colors of the plurality of videos;
calculating a second adjustment value for adjusting a color of a video output by each of the one or more video output devices based on the plurality of pieces of color information and the first adjustment value; and
causing the plurality of video output devices to output one, as the one video, of (i) a first video obtained by applying the first adjustment value to the one or more video output devices and (ii) a second video obtained by applying the second adjustment value to the one or more video output devices.

2. The video processing method according to claim 1, further comprising causing the plurality of video output devices to output one of the first video and the second video as the one video according to an input by a user.

3. The video processing method according to claim 1, wherein each of the plurality of pieces of color information is spectral information indicating a spectrum of light output from a corresponding video output device of the plurality of video output devices.

4. The video processing method according to claim 1, wherein each of the plurality of pieces of color information is a color value calculated using a color system based on a spectrum of light output from a corresponding video output device of the plurality of video output devices.

5. The video processing method according to claim 1, wherein the calculating of the second adjustment value includes calculating an offset value based on a difference between the plurality of pieces of color information, and calculating the second adjustment value based on the calculated offset value and the first adjustment value.

6. The video processing method according to claim 1, wherein the acquiring of the plurality of pieces of color information includes acquiring the plurality of pieces of color information from a plurality of storage units respectively included in the plurality of video output devices.

7. The video processing method according to claim 1, wherein the acquiring of the plurality of pieces of color information includes acquiring the plurality of pieces of color information from a server device via a network.

8. The video processing method according to claim 1, further comprising causing the plurality of video output devices to output the second video as the one video, and causing the plurality of video output devices to output the first video as a distribution video distributed via a network.

9. The video processing method according to claim 1, wherein
the first adjustment value is a value for adjusting colors of the plurality of videos to be close to each other in the image captured by the imaging device in a case where the plurality of videos are a same video, and
the second adjustment value is a value for adjusting colors of the plurality of videos to be close to each other when the one video is directly viewed in a case where the plurality of videos are the same video.

10. A video processing system comprising:
a first acquisition unit that acquires imaging information including an image obtained by imaging a plurality of videos respectively output from a plurality of video output devices as one video with an imaging device;
a second acquisition unit that acquires a plurality of pieces of color information obtained by measuring respective colors of the plurality of videos; and
a processing unit, wherein
the processing unit
calculates a first adjustment value for adjusting a color of a video output by each of one or more video output devices among the plurality of video output devices based on the imaging information acquired by the first acquisition unit,
calculates a second adjustment value for adjusting a color of a video output by each of the one or more video output devices based on the plurality of pieces of color information acquired by the second acquisition unit and the first adjustment value, and
causes the plurality of video output devices to output one, as the one video, of (i) a first video obtained by applying the first adjustment value to the one or more video output devices and (ii) a second video obtained by applying the second adjustment value to the one or more video output devices.
